(19) United States
(12) Patent Application Publication
(10) Pub. No.: US 2026/0211939 A1
(43) Pub. Date: Jul. 23, 2026

(54) PROCESSING APPARATUS, PROCESSING METHOD, AND NON-TRANSITORY COMPUTER-READABLE MEDIUM

(71) Applicant: NEC Corporation, Tokyo (JP)

(72) Inventors: Noboru YOSHIDA, Tokyo (JP); Atsushi HONDA, Tokyo (JP); Yoshihiro KAJIKI, Tokyo (JP); Takayuki KASE, Tokyo (JP); Ikumu YASUDA, Tokyo (JP); Takumi OZAKI, Tokyo (JP); Jianquan LIU, Tokyo (JP); Tingting DONG, Tokyo (JP)

(73) Assignee: NEC Corporation, Tokyo (JP)

(21) Appl. No.: 19/157,750

(22) PCT Filed: Feb. 1, 2024
(86) PCT No.: PCT/JP2024/003234

§ 371 Date: Aug. 19, 2025

(30) Foreign Application Priority Data
Mar. 29, 2023 (JP) 2023-052965

(51) Int. Cl. G06F 16/532; G06F 16/632; G06F 40/279; G06Q 50/26; G06T 7/246; G10L 25/51

(52) U.S. Cl. CPC G06F 16/532; G06F 16/634; G06F 40/279; G06T 7/246; G10L 25/51; G06Q 50/265; G06T 2207/30196

(57) ABSTRACT

The present invention provides a processing device comprising: a reception unit that acquires witness information indicating the content of a witness's testimony; an appearance feature identification unit that identifies a plurality of items about appearance features for a tracked person on the basis of the witness information; a reliability determination unit that determines the reliability of each identified appearance feature on the basis of the witness information; and a search query generation unit that, on the basis of the identified appearance features and the reliability of each identified appearance feature, generates a search query used when searching for the tracked person within an image.

### TECHNICAL FIELD

The present invention relates to a processing device, a processing method, and a program.

### BACKGROUND ART

Techniques according to the present invention are disclosed in PTL 1 to PTL 3.

The technique disclosed in PTL 1 is a technique for searching for a suspect or a criminal of an incident or an accident. In this technique, a police operator listens to information regarding a suspect or a criminal from a reported witness, and inputs the information to a system as a search key. The system searches for a suspect or a criminal in an image based on the search key.

According to the technique disclosed in PTL 2, reliability of witness information is determined, and witness positions are plotted and displayed on a map in order from the witness information with high reliability. The reliability of the witness information is determined based on the number of pieces of witness information near the witness positions.

The technique disclosed in PTL 3 generates a search condition for searching for a suspicious person. The search conditions include “where were you at a certain time”, “what color of clothes you were wearing”, “in which direction you were heading”, and “how fast you were moving”. For a time and a place, it is disclosed that a period of time and an area are determined, and a person who is at the period of time and the area is set as a candidate because the witness information includes ambiguity.

### CITATION LIST

### Patent Literature

PTL 1: JP 2019-36872 A
PTL 2: JP 2007-226292 A
PTL 3: JP 2014-235608 A

### SUMMARY OF INVENTION

### Technical Problem

The present inventors have found that search accuracy deteriorates due to the following reasons in a technique for generating a search query based on witness information and searching for a tracking target person in an image based on the search query.

There is a case where appearance features of a plurality of items of the tracking target person are indicated by the witness information by one witness. Examples of the items of the appearance features include, but are not limited to, sex, an age, hairstyle, a body shape, presence or absence of a hat, a type of hat, color of the hat, presence or absence of glasses, a type of glasses, and color of the glasses.

Even in the case of the appearance features stated by the same witness, reliability may differ for each appearance feature. For example, while reliability of an appearance feature regarding “item: sex” is high, reliability of an appearance feature regarding “item: age” is low. An appearance feature with high reliability is effective in searching for a tracking target person, but an appearance feature with low reliability may reduce accuracy of the search. In a case where a search query is generated by uniformly and similarly treating a plurality of appearance features indicated by the witness information without considering reliability of each appearance feature indicated by the witness information, accuracy of the search may deteriorate.

PTL 1 discloses a technique for generating a search query based on witness information, but does not disclose a technique for generating a search query in consideration of reliability of the witness information.

PTL 2 discloses a technique for plotting witness information on a map in consideration of the reliability of the witness information, but does not disclose a technique for generating a search query in consideration of the reliability of the witness information. PTL 2 does not disclose a technical idea of executing a predetermined process in consideration of the reliability of each of a plurality of appearance features indicated by the witness information.

PTL 3 discloses that a period of time and an area are determined for a time and a place, and the period of time and the person who was in the specified time period and area may be a candidate, but does not disclose a technique for generating a search query in consideration of the reliability of the witness information.

In view of the above-described problems, an object of the present invention is to provide a processing device, a processing method, and a program for improving search accuracy in a technique for generating a search query based on witness information of a witness and searching for a tracking target person in an image based on the search query.

### Solution to Problem

According to an example aspect of the present invention,
there is provided a processing device including
reception means for acquiring witness information indicating content of a witness's statement,
appearance feature specification means for specifying appearance features of a plurality of items about a tracking target person based on the witness information, and
reliability determination means for determining reliability of each of the specified appearance features based on the witness information, and
search query generation means for generating a search query used in a case of searching for the tracking target person in an image based on the specified appearance features and the reliability of each of the specified appearance features.

According to an example aspect of the present invention,
there is provided a processing method causing one or more computers to execute
acquiring witness information indicating content of a witness's statement,
specifying appearance features of a plurality of items about a tracking target person based on the witness information, and
determining reliability of each of the specified appearance features based on the witness information, and
generating a search query used in a case of searching for the tracking target person in an image based on the specified appearance features and the reliability of each of the specified appearance features.

According to an example aspect of the present invention,
there is provided a program for causing a computer to function as
reception means for acquiring witness information indicating content of a witness's statement,
appearance feature specification means for specifying appearance features of a plurality of items about a tracking target person based on the witness information, and
reliability determination means for determining reliability of each of the specified appearance features based on the witness information, and
search query generation means for generating a search query used in a case of searching for the tracking target person in an image based on the specified appearance features and the reliability of each of the specified appearance features.

### Advantageous Effects of Invention

According to an example aspect of the present invention, a processing device, a processing method, and a program for improving search accuracy are implemented in a technique for generating a search query based on witness information and searching for a tracking target person in an image based on the search query.

### BRIEF DESCRIPTION OF DRAWINGS

The above-described object and other objects, features, and advantages will be further clarified by the following suitable example embodiments and accompanying drawings.

FIG. 1 It is a diagram illustrating an example of a functional block diagram of a processing device.

FIG. 2 It is a diagram illustrating an example of a hardware configuration of the processing device.

FIG. 3 It is a diagram schematically illustrating an example of information processed by the processing device.

FIG. 4 It is a diagram schematically illustrating another example of information processed by the processing device.

FIG. 5 It is a flowchart illustrating an example of a flow of a process of the processing device.

FIG. 6 It is a diagram illustrating an example of a functional block diagram of the processing device.

### EXAMPLE EMBODIMENT

Hereinafter, example embodiments of the present invention will be described with reference to the drawings. In all the drawings, the same components are denoted by the same reference numerals, and description thereof will be omitted as appropriate.

### First Example Embodiment

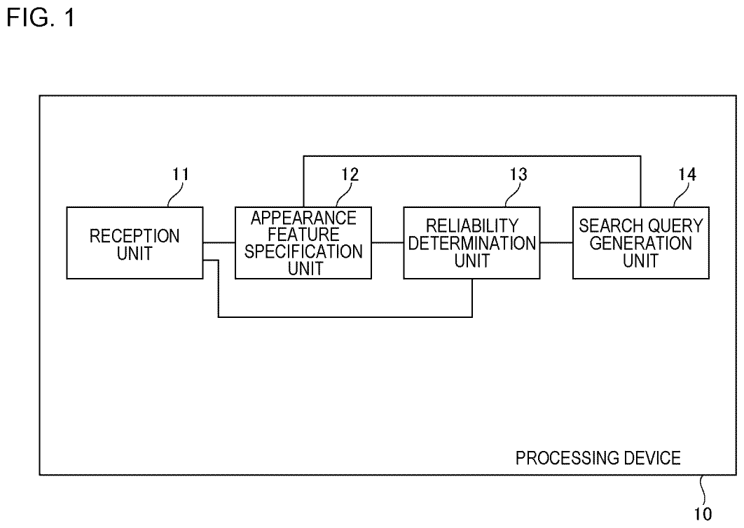

FIG. 1 is a functional block diagram illustrating an outline of a processing device 10 according to a first example embodiment. The processing device 10 includes a reception unit 11, an appearance feature specification unit 12, a reliability determination unit 13, and a search query generation unit 14.

The reception unit 11 acquires the witness information indicating content of a witness's statement. The appearance feature specification unit 12 specifies appearance features of a plurality of items of the tracking target person based on the witness information. The reliability determination unit 13 determines the reliability of each of the specified appearance features based on the witness information. The search query generation unit 14 generates a search query used in a case where the tracking target person is searched for in the image based on the specified appearance features and the reliability of each of the specified appearance features.

The processing device 10 according to the present example embodiment determines the reliability of each appearance feature of a plurality of items of the tracking target person indicated by the witness information. Then, the processing device 10 generates a search query in consideration of the reliability of each appearance feature. In the processing device 10, it is possible to generate a search query with which the tracking target person can be searched for in an image with high accuracy.

### Second Example Embodiment

### “Overview”

The processing device 10 according to a second example embodiment is obtained by embodying the processing device 10 according to the first example embodiment. That is, the processing device 10 determines the reliability of each appearance feature of a plurality of items of a tracking target person indicated by witness information, and generates a search query in consideration of the reliability of each appearance feature. Hereinafter, a configuration of the processing device 10 will be described in detail.

“hardware Configuration”

An example of a hardware configuration of the processing device 10 will be described. Each functional unit of the processing device 10 is implemented by any combination of hardware and software. It is to be understood by those skilled in the art that there are various modifications of an implementation method and the device. The software includes a program stored in advance from a stage of shipping the device, a program downloaded from a recording medium such as a compact disc (CD), a server on the Internet, or the like.

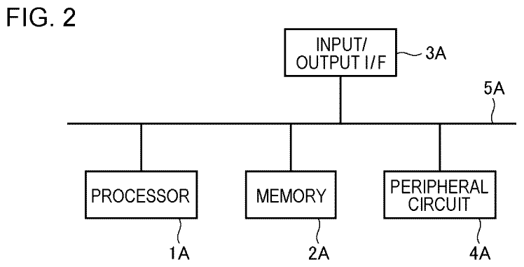

FIG. 2 is a block diagram illustrating a hardware configuration of the processing device 10. As illustrated in FIG. 2, the processing device 10 includes a processor 1A, a memory 2A, an input/output interface 3A, a peripheral circuit 4A, and a bus 5A. The peripheral circuit 4A includes various modules. The processing device 10 may not include the peripheral circuit 4A. The processing device 10 may include a plurality of physically and/or logically separated devices. In this case, each of the plurality of devices can have the above-described hardware configuration.

The bus 5A is a data transmission path through which the processor 1A, the memory 2A, the peripheral circuit 4A, and the input/output interface 3A mutually transmit and receive data. The processor 1A is, for example, an arithmetic processing unit such as a CPU or a graphics processing unit (GPU). The memory 2A is, for example, a memory such as a random access memory (RAM) or a read only memory (ROM). The input/output interface 3A includes an interface for acquiring information from an input device, an external device, an external server, an external sensor, or the like and a camera, and an interface for outputting information to an output device, an external device, an external server, or the like. The input/output interface 3A includes an interface for connection to a communication network such as the Internet. The input device is, for example, a keyboard, a mouse, a microphone, a physical button, a touch panel, or the like. The output device is, for example, a display, a speaker, a printer, a mailer, or the like. The processor 1A can issue a command to each module and execute calculation based on a calculation result.

### “Functional Configuration”

Next, a functional configuration of the processing device 10 according to the present example embodiment will be described in detail. FIG. 1 illustrates an example of a functional block diagram of a processing device 10 according to the present example embodiment. As illustrated, the processing device 10 according to the present example embodiment includes a reception unit 11, an appearance feature specification unit 12, a reliability determination unit 13, and a search query generation unit 14.

The reception unit 11 acquires the witness information indicating content of a witness's statement.

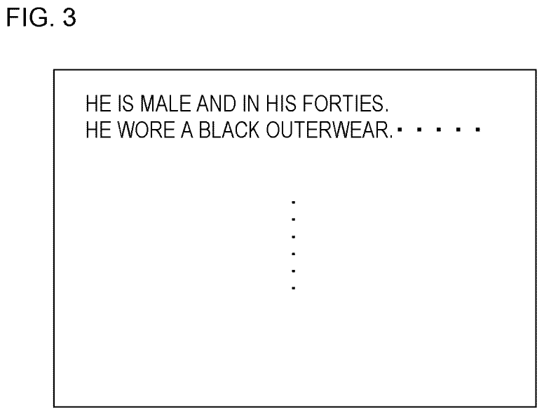

The “witness information” includes text data indicating conversation content during the witness's statement. FIG. 3 illustrates an example of the witness information. FIG. 3 illustrates conversation content in a case where the appearance features related to the tracking target person are stated. The witness information indicates statement content such as “The person is a man. The age is in forties.” during a witness's statement as it is. That is, in the witness information, wording, an expression, or the like used by the witness during the statement is indicated as it is.

Additionally, the witness information may include voice data indicating conversation content during the witness's statement. For example, the reception unit 11 may have a transcription function. Then, the reception unit 11 may execute voice analysis on the voice data to generate the above-described text data. A user may generate the above-described text data and input the text data to the processing device 10.

Incidentally, the voice data can include not only conversation content of the witness but also conversation content of another person who is talking with the witness. In a case where the reception unit 11 analyzes the voice data and generates the above-described text data, the reception unit 11 may generate the text data indicating all the conversation content of the witness and another person as the witness information. Additionally, the reception unit 11 may identify a plurality of speakers using a speaker recognition technique and generate text data indicating conversation content for each speaker.

The “acquisition” includes at least one of an own device that executes obtaining data or information stored in another device or a storage medium (active acquisition) and an own device that receives an input of data or information output from another device (passive acquisition). Examples of the active acquisition include making a request or the like to another device and receiving a reply to the request, and accessing another device or a storage medium for reading. Examples of the passive acquisition include receiving information distributed (alternatively, transmission, push notification, or the like). Further, “acquisition” may be selecting and acquiring from received data or information, or selecting and receiving distributed data or information.

Returning back to FIG. 1, the appearance feature specification unit 12 specifies appearance features of a plurality of items of the tracking target person based on the witness information acquired by the reception unit 11.

The appearance feature specification unit 12 extracts keywords related to items and appearance features from the text data (witness information). Then, the appearance feature specification unit 12 specifies appearance features of a plurality of items of the tracking target person based on an extraction result.

All the text data (witness information) acquired by the reception unit 11 may be data of the processing target by the appearance feature specification unit 12. Additionally, some of the text data (witness information) acquired by the reception unit 11 may be data of the processing target by the appearance feature specification unit 12. In the latter case, for example, the user designates some of the text data (witness information) as the target processing by the appearance feature specification unit 12. The operation of designating some of the text data is implemented by using any technique.

The “keywords” are registered in advance in the processing device 10. The keywords are names and abbreviations of items, names and abbreviations of the appearance features that can be taken by the items, and the like.

The “items” relate to features of a person that can be extracted from her or his appearance, that is, features of a person that can be extracted through image analysis. Examples of the items include, but are not limited to, sex, an age, hairstyle, a body shape, presence or absence of a hat, a type of hat, color of the hat, presence or absence of glasses, a type of glasses, color of the glasses, color of clothes, design of the clothes, color of belongings, and design of the belongings.

The appearance features that can be taken by the item “sex” are male and female.

The appearance features that can be taken by the item “age” may be age itself or ages such as teenagers and twenties.

The appearance features that can be taken by the item “hairstyle” are classifications of hairstyles such as a shaved head, a semi-long hairstyle, and the like.

The appearance features that can be taken by the item “body shape” are classifications of body shapes such as a thin type, a plump type, and the like.

The appearance feature for the item “presence or absence of a hat” is present (worn) or absent (not worn).

The appearance feature for the item “type of the hat” is classification of the hat such as a cap, a hunting cap, and a knit hat.

The appearance feature for the item “color of a hat” is color such as red or black.

The appearance feature for the item “presence or absence of glasses” is present (worn) or absent (not worn).

The appearance feature for the item “type of glasses” is classification based on the shape of a frame or rim. For example, an oval, a square, a round, a full rim, a half rim, no rim, and the like are exemplified.

The appearance feature for the item “color of glasses” is color such as red or black.

The appearance feature for the item “color of clothes” is color such as red or black.

The appearance features that can be taken by the item “design of clothing” are classifications of clothing such as miniskirts, pants, T-shirts, and coats. The appearance features that can be taken by the item “design of clothing” may be obtained by further subdividing the classification of clothing. For example, the coats can be subdivided like a down coat or a duffle coat. Trousers and outerwear can be subdivided into formal and casual trousers and outerwear.

The appearance feature for the item “color of belongings” is color such as red or black.

The appearance features that can be taken by the item “design of belongings” are classification of belongings such as a bag and an umbrella. The appearance features that can be taken by the item “design of belongings” may be obtained by further subdividing the classification of the belongings. For example, bags can be subdivided into a backpack or a business bag.

Various configurations can be adopted for the process of specifying the appearance features of the plurality of items of the tracking target person based on a keyword extraction result. Hereinafter, an example will be described, but the present invention is not limited thereto. For example, in a case where a name, an abbreviation, or the like of an appearance feature is extracted from text data (witness information), the appearance feature specification unit 12 may specify the appearance feature as the appearance feature of the tracking target person. The appearance feature specification unit 12 may parse the text data (witness information) and specify a dependency relationship between the extracted keywords, more specifically, “a name or abbreviation of an item” and “a name or abbreviation of an appearance feature” having a dependency relationship with each other. The appearance feature specification unit 12 may specify the appearance feature of the item as the appearance feature of the tracking target person. The appearance feature specification unit 12 may parse the text data (witness information) to specify whether the extracted appearance feature has a dependency relationship with any of a negative expression such as “not” and an affirmative expression such as “is”. Then, the appearance feature specification unit 12 may specify an appearance feature having a dependency relationship with an affirmative expression as the appearance feature of the tracking target person.

The reliability determination unit 13 determines the reliability of each of the specified appearance features based on the witness information. The reliability determination unit 13 according to the present example embodiment determines reliability of each of the specified appearance features based on the text data (witness information). In the following example embodiment, a process of determining the reliability of each of the specified appearance features based on the voice data (witness information) will be described.

The reliability determination unit 13 specifies an expression used during the statement of the appearance feature from the text data (the witness information). Then, the reliability determination unit 13 determines the reliability of the appearance feature based on the type of expression.

The type of expression includes an affirmative expression and an ambiguous expression. The reliability determination unit 13 sets the reliability of the appearance feature in which the affirmative expression is used during the statement of the appearance feature to be higher than the reliability of the appearance feature in which the ambiguous expression is used during the statement of the appearance feature.

The “affirmative expression” is an expression such as “Is”, “Was”, “No mistake”, or “I am sure”. It is considered that a witness uses an affirmative expression in a case where the witness states a confident appearance feature.

“Ambiguous expressions” are expressions that obscure remark content such as “I think it was”, “Perhaps”, “Likely”, “Maybe”, or “~-like” (for example, reddish color). It is considered that the witness uses an ambiguous expression in a case where an unconfident appearance feature is stated.

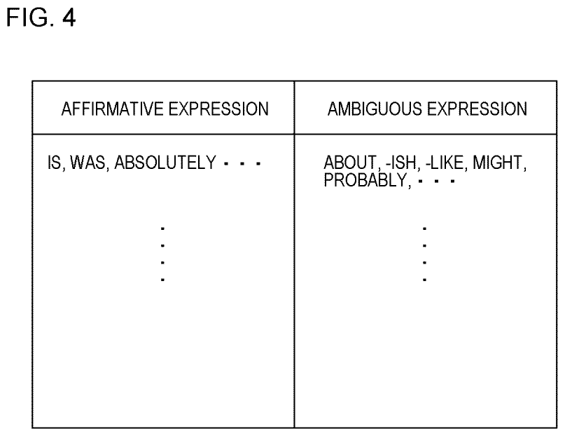

An expression dictionary (see FIG. 4) in which a plurality of affirmative expressions and ambiguous expressions are recorded is generated in advance and stored in the processing device 10. Based on the expression dictionary, the reliability determination unit 13 specifies an expression used during the statement of the appearance feature from the text data (witness information). For example, the reliability determination unit 13 specifies an expression that has a dependency relationship with the appearance feature (an appearance feature extracted from text data (witness information)) stated as an expression used during the statement of the appearance feature. Additionally, the reliability determination unit 13 may parse the text data (witness information) and divide the text data into sentences. The reliability determination unit 13 may specify an expression that is in the same sentence as the appearance feature (the appearance feature extracted from the text data (witness information)) stated as an expression used during the statement of the appearance feature.

Next, a process of determining the reliability of each appearance feature based on the type of expression used during the statement of each appearance feature will be described. The reliability determination unit 13 can execute, for example, the following reliability determination processing example 1 or reliability determination processing example 2.

### Reliability Determination Processing Example 1

A one example, the reliability is determined in advance for each expression registered in the expression dictionary. For example, the reliability of “I am sure” is 100, the reliability of “Is” is 90, the reliability of “I think it was” is 50, the reliability of “Perhaps” is 30, and the like. The reliability determination unit 13 determines the reliability of each of the specified appearance features based on the reliability for each expression.

For example, the reliability determination unit 13 can determine, as the reliability of a certain appearance feature, the reliability of an expression used during the statement of the appearance feature. In a case where there is a plurality of expressions used during the statement of the appearance feature, the reliability determination unit 13 can determine statistical values of the reliability of the plurality of expressions as the reliability of the appearance features. The statistical value is a maximum value, a minimum value, an average value, a mode value, a median value, or the like, but is not limited thereto.

### Reliability Determination Processing Example 2

As another example, the reliability of the appearance feature in which the expression used during statement is an affirmative expression and the reliability of the appearance feature in which the expression used during statement is an ambiguous expression may be fixed and determined in advance. For example, the reliability of an appearance feature of which an expression used during statement is an affirmative expression is 100, the reliability of an appearance feature of which an expression used during statement is an ambiguous expression is 30, and the like. The reliability determination unit 13 may determine the reliability of each appearance feature by two values of the reliability of the appearance feature in which the expression used during statement is an affirmative expression and the reliability of the appearance feature in which the expression used during statement is an ambiguous expression. Further, the reliability in a case where an affirmative expression and an ambiguous expression are mixed in the expression used during the statement may be further determined. For example, the reliability in this case is 50 or the like. The reliability determination unit 13 may determine the reliability of each appearance feature using the two values and three values of the reliability in a case where an affirmative expression and an ambiguous expression are mixed in the expression used during the statement.

The search query generation unit 14 generates a search query used in a case of searching for the tracking target person in the image based on the appearance feature specified by the appearance feature specification unit 12 and the reliability of each specified appearance feature. The reliability of each specified appearance feature is the reliability determined by the reliability determination unit 13. The search query generation unit 14 can execute, for example, the following search query generation processing example 1 or search query generation processing example 2.

### Search Query Generation Processing Example 1

The search query generation unit 14 can generate a search query that includes appearance features of which reliability is equal to or more than the threshold and does not include appearance features of which reliability is below the threshold. For example, the search query generation unit 14 generates a search query in which appearance features with reliability equal to or more than the threshold are connected by any logical operator. An example of the search query is “sex: male, age: thirties, and presence or absence of a hat: presence” or the like. The threshold is a value determined in advance.

### Search Query Generation Processing Example 2

The search query generation unit 14 can generate a search query including “appearance features specified based on the witness information” and “an appearance feature not specified based on the witness information, but has a similar relationship with an appearance feature of which the reliability is below the threshold”.

The search query generation unit 14 generates an item-specific condition for each item. Then, the search query generation unit 14 generates a search query in which the plurality of generated conditions for each item are connected by any logical operator.

The search query generation unit 14 generates a condition for each item so that the following rules are satisfied.
A condition for each item including only an appearance feature is generated to be relevant to an item in which the appearance feature of which the reliability is equal to or more than the threshold is specified based on the witness information.
A condition for each item in which an appearance feature of which the reliability is below the threshold is connected to an appearance feature that has a similar relationship with the appearance feature under an OR condition is generated to be relative to an item for which the appearance feature is specified based on the witness information.
A condition for each item is not generated for an item for which an appearance feature is not specified based on the witness information.

An example of the search query is “sex: male, age: twenties, thirties, or forties, and presence or absence of a hat: presence” or the like. For “item: sex” and “item: presence or absence of a hat”, appearance features (male, presence of a hat) that have reliability equal to or more than the threshold are specified. Therefore, the condition is set for each item including only the appearance features. On the other hand, for “item: age”, an appearance feature of which the reliability is below the threshold is specified. Therefore, a condition for each condition is that connects the appearance feature (thirties) and the appearance feature (twenties, forties) that has a similar relationship with the appearance feature under the OR condition.

A similar relationship dictionary indicating the similar relationship between the plurality of appearance features is generated in advance and stored in the processing device 10. The search query generation unit 14 specifies another appearance feature that has a similar relationship with a certain appearance feature based on the similar relationship dictionary.

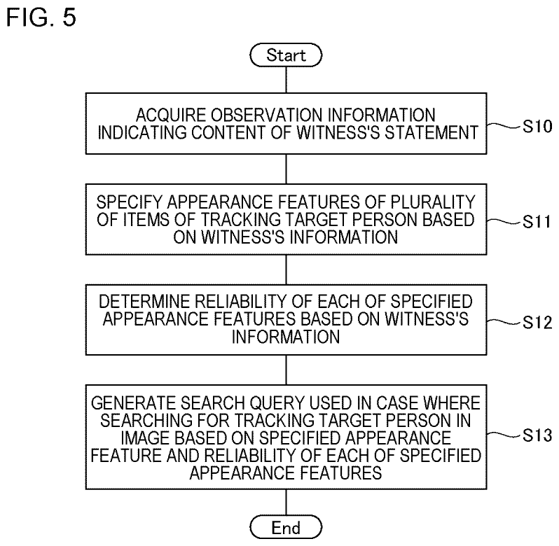

Next, an example of a flow of process of the processing device 10 will be described with reference to the flowchart of FIG. 5.

The processing device 10 first acquires the witness information indicating witness content by the witness (S10). For example, as illustrated in FIG. 3, the processing device 10 acquires text data indicating conversation content during the witness's statement as the witness information.

Subsequently, the processing device 10 specifies the appearance features of the plurality of items of the tracking target person based on the witness information acquired in S10 (S11). For example, the processing device 10 extracts keywords related to the items and the appearance features from the text data (witness information), and specifies the appearance features of the plurality of items of the tracking target person based on an extraction result.

Subsequently, the processing device 10 determines the reliability of each of the appearance features specified in S11 based on the witness information acquired in S10 (S12). For example, the processing device 10 specifies the expression used during the statement of each appearance feature specified in S11 from the text data (witness information), and determines the reliability of each appearance feature based on the type of expression. The expression includes an affirmative expression and an ambiguous expression. The processing device 10 sets the reliability of the appearance feature in which the affirmative expression is used during the statement to be higher than the reliability of the appearance feature in which the ambiguous expression is used during the statement. The processing device 10 executes, for example, the reliability determination processing example 1 or the reliability determination processing example 2 described above to determine the reliability of each appearance feature.

Subsequently, the processing device 10 generates a search query used in a case of searching for the tracking target person in the image based on the appearance feature specified in S11 and the reliability of each of the appearance features determined in S12 (S13). The processing device 10 executes, for example, the search query generation processing example 1 or the search query generation processing example 2 described above to generate the search query.

### “Operations and Effects”

In the processing device 10 according to the present example embodiment, operational effects similar to those of the processing device 10 according to the first example embodiment are implemented.

In the processing device 10 according to the present example embodiment, it is possible to determine the reliability for each appearance feature indicated by the witness information and generate the search query based on the reliability for each appearance feature. For example, the search query can be generated with only appearance features with high reliability. Alternatively, in the appearance features with low reliability, the search query can be generated by connecting other similar appearance features under the OR condition. In the processing device 10, it is possible to generate the search query with which the tracking target person can be accurately detected.

In the processing device 10 according to the present example embodiment, the reliability of each appearance feature can be determined based on the expression used during the statement of each appearance feature. That is, the reliability of the appearance feature using the affirmative expression can be set to be higher than the reliability of the appearance feature using the ambiguous expression. In the processing device 10 that determines the reliability of each appearance feature based on the expression used by the witness during statement, the reliability of each appearance feature can be accurately determined.

### Third Example Embodiment

The processing device 10 according to the present example embodiment acquires text data indicating conversation content during a witness's statement and voice data indicating conversation content during the witness's statement as witness information. The processing device 10 determines the reliability of each appearance feature stated by the witness based on the voice data. The processing device 10 determines the reliability of each appearance feature based on at least one of a feeling of the witness during the statement of each appearance feature, a speaking tempo, and loudness of a voice. Details will be described below.

The reception unit 11 acquires text data indicating the content of conversation during the witness's statement and voice data indicating the conversation content during the witness's statement as the witness information.

The reliability determination unit 13 determines the reliability of each appearance feature based on the voice data during the statement of each appearance feature. The reliability determination unit 13 determines the reliability of each appearance feature based on the feature information of remarks including at least one of the feeling of the witness during the statement of each appearance feature indicated by the voice data, the speaking tempo, and the loudness of the voice.

For example, the reliability determination unit 13 can set the reliability of the appearance feature of which the feeling during statement is a first feeling to be less than the reliability of the appearance feature of which the feeling during the statement is another feeling. The first feeling includes, but is not limited to, anxiety, fear, or the like. The reliability determination unit 13 can specify the feeling of the speaker during the statement of each appearance feature using any technique for analyzing the feeling of the speaker through voice analysis. It may be defined that the reliability of the appearance feature in which the feeling during the statement is the first feeling (for example, 30) and the reliability of the appearance feature in which the feeling during the statement is another feeling (for example, 80) may be determined in advance. Then, the reliability determination unit 13 may determine the reliability of each appearance feature with the two values based on the feeling during statement.

The user may designate a section in the voice data in which each appearance feature indicated by the witness information is stated. Additionally, the reliability determination unit 13 may generate data indicating a relevant relationship between each wording in the text data and a speaking timing of each wording (a position in the voice data) in a case where text data indicating the conversation content during witness's statement is generated in the voice recognition process for the voice data. Then, the reliability determination unit 13 may specify a section in the voice data that states each appearance feature specified in the text data based on data indicating the relevant relationship. One section may be relevant to one sentence spoken by a witness.

Additionally, the reliability determination unit 13 can set the reliability of an appearance feature having a relatively slow tempo during the statement lower than the reliability of an appearance feature having a relatively fast tempo during statement. It is considered that in a case where a confident appearance feature is stated, the appearance feature is stated without hesitation and at a good tempo. On the other hand, in a case where an appearance feature that is unconfident is stated, the tempo is considered to be slow because the appearance feature is stated while making a pause using expressions such as “um” and “uh” and evoking memory.

Additionally, the reliability determination unit 13 can cause the reliability of the appearance feature in which the loudness of the voice during the statement is relatively small to be lower than the reliability of the appearance feature in which the loudness of the voice during the statement is relatively large. It is considered that in a case where a confident appearance feature is stated, the appearance feature is stated clearly in a firm voice. On the other hand, it is considered that the appearance feature that is unconfident is stated with a small voice and confidence in a case where an appearance feature that is not confident is stated.

For example, the reliability determination unit 13 may compare a plurality of pieces of feature information of remarks indicated by the voice data during the statement of each of the plurality of appearance features stated by the witness with each other, and determine the reliability of the plurality of appearance features by relative evaluation. That is, the reliability determination unit 13 may determine the reliability of the plurality of appearance features by the relative evaluation based on a comparison result between the tempo and the loudness of voice during the statement of a certain appearance feature and the tempo and the loudness of voice during the statement of another appearance feature.

For example, the reliability determination unit 13 determines a reference value of the witness by treating reliability of the appearance feature serving as the reference value in the remarks feature information as a standard value (for example, 70) and correcting this standard value based on a magnitude relationship with the reference value and the degree of deviation from the reference value. A statistical value such as an average value, a median value, and a mode value can be used as the reference value. The reliability determination unit 13 may determine the reliability of each appearance feature by setting the reliability of the appearance feature of the reference value of the feature information as a standard value (for example, 70) and correcting the standard value based on a magnitude relationship with the reference value and the degree of deviation from the reference value. A correction scheme is a matter of design.

In a case where the voice data acquired by the reception unit 11 indicates conversation content (greeting, a small talk, self-introduction, or the like) other than during the statement, the reliability determination unit 13 may determine the reliability of each appearance feature using the voice data of a conversation portion other than during the statement. For example, the reliability determination unit 13 may determine the reference value using the voice data of the conversation portion other than during the statement. That is, the reliability determination unit 13 may analyze the voice data of the conversation portion other than during the statement and specify the tempo and the loudness of a voice. Then, the reliability determination unit 13 may use the specified tempo and the specified loudness of voice as the reference value. Alternatively, the reliability determination unit 13 may use, as the reference value, a statistical value (an average value, a median value, a mode value, or the like) of the specified tempo and loudness of voice and the tempo and the loudness of voice during the statement of each of the plurality of appearance features.

Other configurations of the processing device 10 according to the present example embodiment are similar to those of the processing devices 10 according to the first and second example embodiments.

In the processing device 10 according to the present example embodiment, functions and effects similar to those of the processing devices 10 according to the first and second example embodiments are implemented.

In the processing device 10 according to the present example embodiment, it is possible to determine the reliability of each appearance feature based on the voice data indicating the conversation content during the witness's statement. Specifically, the processing device 10 can determine the reliability of each appearance feature based on the feeling of the witness during the statement of each appearance feature, the speaking tempo, the loudness of the voice, and the like. In the processing device 10, it is possible to accurately determine the reliability of each appearance feature. As a result, it is possible to generate a search query with which the tracking target person can be accurately detected.

### Fourth Example Embodiment

The processing device 10 according to the present example embodiment can determine the reliability of each appearance feature in consideration of the witness features of the witness. Details will be described below.

The reception unit 11 acquires the witness feature information indicating features of the witness. The user inputs the witness feature information to the processing device 10. The input is implemented via any input device such as a keyboard, a touch panel, a microphone, or a physical button.

The “witness feature information” includes at least one of a date and time of the witness, weather during witness, an attribute of the witness, an elapsed time from a time of the witness to a time of the statement, a temporal length of time in which the witness has observed the witness target, and a distance between the witness and the witness target.

The reliability determination unit 13 determines the reliability of the appearance feature by further using the witness feature information. The reliability determination unit 13 corrects the reliability of each appearance feature determined by the scheme described in the above example embodiment based on the witness feature information, and determines the reliability of each appearance feature.

A correction rule is defined in advance for each item according to the witness feature information. The reliability determination unit 13 corrects the reliability of each appearance feature determined by the scheme described in the above example embodiment based on the correction rule.

Here, the correction rule for each item will be described.

In “item: age”, the reliability of a stated appearance feature is affected by the age of the witness. For example, in a case where the witness is very young, such as a child who is under 10 years old or a teenager, or in a case where the witness is relatively old, such as the old who is equal to or more than 80 years old, it is considered that an ability to identify the age is inferior to a case where the witness is at other ages. For this reason, in “item: age”, it is preferable to correct the reliability of the appearance feature stated according to the age of the witness.

For example, in the correction rule of “item: age”, it may be defined that, in a case where the age of the witness is under 10 years old, a teenager, or equal to or more than 80 years old, the reliability of the stated appearance feature is lower (for example, reduced by X₁%, or the like). Then, in the correction rule of “item: age”, it may be defined that the reliability of the stated appearance feature is not corrected in a case where the age of the witness is other.

On the other hand, in “item: sex”, the reliability of the stated appearance feature is less affected by the age of the witness. Therefore, in “item: sex”, the reliability of the stated appearance feature may not be corrected according to the age of the witness. Alternatively, in “item: sex”, the degree of correction of the reliability of the stated appearance feature may be set less than the degree of correction of the reliability of the appearance feature in the “item: age”. “Setting the degree of correction to be less” means a decrease in the amount of change in reliability by correction.

For example, in the correction rule of “item: sex”, the correction according to the age of the witness may not be defined (that is, the correction according to the age of the witness is not executed). Alternatively, in the correction rule of “item: sex”, it may be defined that, in a case where the age of the witness is under 10 years old, a teenager, or equal to or more than 80 years old, the reliability of the appearance feature stated is lowered (for example, a decrease by X₂%, or the like). X₂ is a value less than X₁. Then, in the correction rule of “item: sex”, it may be defined that the reliability of the appearance feature stated is not corrected in a case where the age of the witness is other.

In “item: presence or absence of glasses”, the reliability of the stated appearance feature is not much affected by surrounding brightness during witness. On the other hand, in “item: color of glasses”, the reliability of the stated appearance feature is affected by the surrounding brightness during witness. That is, in a case where the surroundings during the witness are dark, there is a possibility of the color being erroneously recognized. For example, the correction rule for each item may be generated in consideration of the possibility of such erroneous recognition for each item. In this case, the reliability of the appearance feature or the like in “item: color of glasses” is corrected according to a date and time of the witness, the weather during the witness, or the like.

For example, in the correction rule of “item: color of glasses”, it may be defined that the reliability of the stated appearance feature is lowered in a case where the weather during witness is cloudy, rainy, or snowy. In the correction rule of the “item: color of glasses”, it may be defined that lower the reliability of the stated appearance feature in a case where the time during the witness is in a predetermined period of time (nighttime). The predetermined period of time (nighttime) may be determined for each month and day. In the correction rule of the “item: color of glasses”, it may be defined that the reliability of the stated appearance feature is not corrected in a case where the weather or the date and time is other.

On the other hand, the reliability of the appearance feature in “item: presence or absence of glasses” may not be corrected according to the date and time of the witness, the weather during the witness, and the like. Alternatively, the degree of correction of the reliability of the appearance feature in “item: presence or absence of glasses” may be less than the degree of correction of the reliability of the appearance feature in “item: color of glasses”.

Additionally, of the plurality of items, there are a plurality of items in which the reliability of the stated appearance feature is affected by the elapsed time from the time of the witness to the time of the statement, a temporal length of a time in which the witness observes the witness target, a distance between the witness and the witness target, and the like, and a plurality of items in which the reliability is not affected (or less affected). In the correction rule for each item, an appropriate correction rule is determined for each item in consideration of this point.

Other configurations of the processing device 10 according to the present example embodiment are similar to those of the processing devices 10 of the first to third example embodiments.

In the processing device 10 according to the present example embodiment, functions and effects similar to those of the processing devices 10 according to the first to third example embodiments are implemented.

In the processing device 10 according to the present example embodiment, it is possible to correct the reliability of each of the stated appearance features in consideration of the influence of various features of the witness on the reliability of the appearance feature of each item. Various features of the witness are indicated by a date and time of the witness, weather during the witness, an attribute of the witness, an elapsed time from the time of the witness to the time of the statement, a temporal length of the witness by the witness, a distance between the witness and the witness target, and the like. In the processing device 10, it is possible to appropriately correct the reliability of each of the stated appearance features according to various features of the witness, and accurately determine the reliability of each of the appearance features. As a result, it is possible to generate a search query with which the tracking target person can be accurately detected.

### Fifth Example Embodiment

The processing device 10 according to the present example embodiment generates a search query further including appearance features having a similar relationship with the appearance features stated in the predetermined expression. Details will be described below.

The search query generation unit 14 generates a search query including appearance features having a similar relationship with appearance features stated in a predetermined expression.

The “predetermined expression” is an expression that obscures the appearance features themselves, such as “-ish” and “-like”. Specifically, it can be stated as “glasses of red-like color”, “glasses of reddish color”, and the like. An expression dictionary in which such a predetermined expression is recorded is generated in advance and stored in the processing device 10. The search query generation unit 14 detects the predetermined expression used during the statement of the appearance feature from the text data (the witness information) based on the expression dictionary.

In a case where such a predetermined expression is detected, the search query generation unit 14 generates a search query including appearance features that have a similar relationship with the appearance features stated in such a predetermined expression.

A similar relationship dictionary indicating the similar relationship between a plurality of appearance features is generated in advance and stored in the processing device 10. The search query generation unit 14 specifies another appearance feature that has a similar relationship with a certain appearance feature based on the similar relationship dictionary.

The search query generation unit 14 generates a search query that connects the appearance features stated in the predetermined expression and the appearance features that have a similar relationship with the appearance features under the OR condition. Specifically, as described in the second example embodiment, the search query generation unit 14 can generate the condition for each item and generate a search query in which the plurality of generated conditions for each item are connected by any logical operator. The search query generation unit 14 generates a condition for each item in which the appearance feature stated in the predetermined expression and the appearance features that have a similar relationship with the appearance features are connected by the OR condition.

Other configurations of the processing device 10 according to the present example embodiment are similar to those of the processing devices 10 according to the first to fourth example embodiments.

In the processing device 10 according to the present example embodiment, functions and effects similar to those of the processing devices 10 according to the first to fourth example embodiments are implemented.

In the processing device 10 according to the present example embodiment, in a case where an appearance feature is stated in an expression obscuring the appearance features themselves, such as “glasses of red-like color”, “glasses of reddish color”, or the like, a search query can be generated, including appearance features similar to the appearance features. In the processing device 10, it is possible to generate the search query with which the tracking target person can be accurately detected.

### Sixth Example Embodiment

The processing device 10 according to the present example embodiment searches for the tracking target person using the search query generated by the search query generation unit 14. Details will be described below.

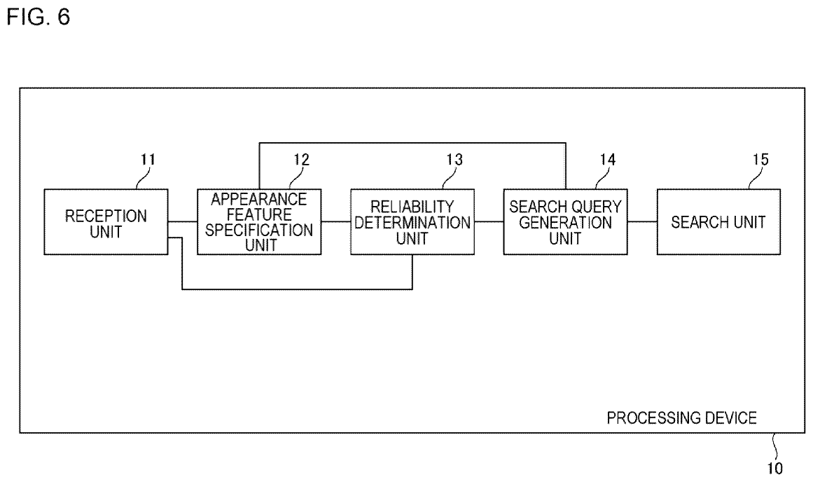

FIG. 6 illustrates an example of a functional block diagram of the processing device 10 according to the present example embodiment. As illustrated, the processing device 10 according to the present example embodiment includes a reception unit 11, an appearance feature specification unit 12, a reliability determination unit 13, a search query generation unit 14, and a search unit 15.

The search unit 15 searches for the tracking target person from the image using the search query generated by the search query generation unit 14. That is, the search unit 15 searches for a person satisfying a condition of the appearance features indicated by the search query generated by the search query generation unit 14 in the image. The searching is implemented using any technique. A search target image is input to the processing device 10 by any means. The image is a concept including a moving image and a still image.

Other configurations of the processing device 10 are similar to those of the first to fifth example embodiments.

According to the processing device 10 of the present example embodiment, operational effects similar to those of the first to fifth example embodiments are implemented. The processing device 10 according to the present example embodiment searches for the tracking target person using the search query generated by the characteristic scheme as described in the above example embodiment. According to the processing device 10, it is possible to accurately search for the tracking target person.

### Modifications

A modification is applicable to the first to sixth example embodiments. In the above-described example embodiment, the appearance feature is specified or the reliability is determined by analyzing text data (witness information) and detecting a predetermined word (a keyword or various expressions). As the modification, voice data may be analyzed to detect a predetermined word (a keyword or various expressions) from the voice data. In the modification, the same effects as those of the above example embodiment are also implemented.

Although the example embodiments of the present invention have been described above with reference to the drawings, these are examples of the present invention, and various configurations other than the above can also be used. The configurations of the above-described example embodiments may be combined with each other, or some of the configurations may be replaced with other configurations. The configurations of the above-described example embodiments may be modified in various forms within a range without departing from the gist. The configurations and processes disclosed in the above-described example embodiments and modifications may be combined with each other.

In the flowchart used in the above description, a plurality of steps (processes) are described in order. However, an execution order of the steps executed in each example embodiment is not limited to the described order. In each example embodiment, the order of the illustrated steps can be changed within a range in which there is no problem in terms of content. The above-described example embodiments can be combined within a range in which the contents are not contradictory.

Some or all of the above example embodiments may be described as the following supplementary notes, but are not limited to the following.
1. A processing device including:
reception means for acquiring witness information indicating content of a witness's statement;
appearance feature specification means for specifying appearance features of a plurality of items about a tracking target person based on the witness information; and
reliability determination means for determining reliability of each of the specified appearance features based on the witness information; and
search query generation means for generating a search query used in a case of searching for the tracking target person in an image based on the specified appearance features and the reliability of each of the specified appearance features.
2. The processing device according to 1, wherein the search query generation means generates the search query including the appearance feature of which reliability is equal to or more than a threshold and not including the appearance feature of which reliability is below the threshold.
3. The processing device according to 1, wherein the search query generation means generates the search query including the appearance features that are specified based on the witness information and the appearance features that are not specified based on the witness information but have a similar relationship with the appearance features of which reliability is below the threshold.
4. The processing device according to 2 or 3, wherein the search query generation means generates the search query including the appearance feature that has a similar relationship with the appearance feature stated in a predetermined expression.
5. The processing device according to any one of 1 to 4, wherein
the witness information includes text data indicating conversation content during the witness's statement,
the appearance feature specification means extracts a keyword related to the item and the appearance feature from the text data and specifies the appearance features of the plurality of the items about the tracking target person based on an extraction result, and
the reliability determination means specifies an expression used during the statement of the appearance feature from the text data, and determines the reliability of the appearance feature based on a type of the expression.
6. The processing device according to 5, wherein the reliability determination means sets the reliability of the appearance feature in which an affirmative expression is used during the statement to be higher than the reliability of the appearance feature in which an ambiguous expression is used during the statement.
7. The processing device according to any one of 1 to 6, wherein
the witness information includes voice data indicating conversation content during the witness's statement, and
the reliability determination means determines the reliability of the appearance feature based on the voice data during the statement of the appearance feature.
8. The processing device according to 7, wherein the reliability determination means determines the reliability of the appearance feature based on feature information of remarks including at least one of a feeling, a speaking tempo, and loudness of a voice of the witness during the statement of the appearance feature indicated by the voice data.
9. The processing device according to 8, wherein the reliability determination means compares a plurality of the pieces of feature information of the remarks indicated by the voice data during the statement of each of a plurality of the appearance features stated by the witness with each other, and determines the reliability of the plurality of appearance features by relative evaluation.
10. The processing device according to 8 or 9, wherein the reliability determination means determines the reliability of the appearance features further using the feature information of remarks indicated by voice data in a period of time in which the witness does not state about the appearance feature.
11. The processing device according to any one of 1 to 10, wherein
the reception means acquires witness feature information indicating features of the witness, and
the reliability determination means determines the reliability of the appearance features further using the witness feature information.
12. The processing device according to 11, wherein the witness feature information includes at least one of a date and time of the witness, weather during the witness, an attribute of the witness, an elapsed time from a time of the witness to a time of the testimony, a temporal length in which the witness observes a witness target, and a distance between the witness and the witness target.
13. A processing method causing one or more computers to execute:
acquiring witness information indicating content of a witness's statement;
specifying appearance features of a plurality of items about a tracking target person based on the witness information; and
determining reliability of each of the specified appearance features based on the witness information; and
generating a search query used in a case of searching for the tracking target person in an image based on the specified appearance features and the reliability of each of the specified appearance features.
14. A program that causes a computer to function as:
reception means for acquiring witness information indicating content of a witness's statement;
appearance feature specification means for specifying appearance features of a plurality of items about a tracking target person based on the witness information; and
reliability determination means for determining reliability of each of the specified appearance features based on the witness information; and
search query generation means for generating a search query used in a case of searching for the tracking target person in an image based on the specified appearance features and the reliability of each of the specified appearance features.

This application is based upon and claims the benefit of priority from Japanese patent application No. 2023-052965, filed on Mar. 29, 2023, the disclosure of which is incorporated herein in its entirety by reference.

### REFERENCE SIGNS LIST

10 processing device
11 reception unit
12 appearance feature specification unit
13 reliability determination unit
14 search query generation unit
15 search unit
1A processor
2A memory
3A input/output I/F
4A peripheral circuit
5A bus

What is claimed is:

1. A processing apparatus comprising:
at least one memory configured to store one or more instructions; and
at least one processor configured to execute the one or more instructions to:
acquire witness information indicating content of a witness's statement;
specify appearance features of a plurality of items about a tracking target person based on the witness information;
determine reliability of each of the specified appearance features based on the witness information; and
generate a search query used in a case of searching for the tracking target person in an image based on the specified appearance features and the reliability of each of the specified appearance features.

2. The processing apparatus according to claim 1, wherein the at least one processor is further configured to execute the one or more instructions to generate the search query including the appearance feature of which reliability is equal to or more than a threshold and not including the appearance feature of which reliability is below the threshold.

3. The processing apparatus according to claim 1, wherein the at least one processor is further configured to execute the one or more instructions to generate the search query including the appearance features that are specified based on the witness information and the appearance features that are not specified based on the witness information but have a similar relationship with the appearance features of which reliability is below the threshold.

4. The processing apparatus according to claim 2, wherein the at least one processor is further configured to execute the one or more instructions to generate the search query including the appearance feature that has a similar relationship with the appearance feature stated in a predetermined expression.

5. The processing apparatus according to claim 1, wherein
the witness information includes text data indicating conversation content during the witness's statement,
the at least one processor is further configured to execute the one or more instructions to
extract a keyword related to the item and the appearance feature from the text data,
specify the appearance features of the plurality of the items about the tracking target person based on an extraction result,
specify an expression used during the statement of the appearance feature from the text data, and
determine the reliability of the appearance feature based on a type of the expression.

6. The processing apparatus according to claim 5, wherein the at least one processor is further configured to execute the one or more instructions to set the reliability of the appearance feature in which an affirmative expression is used during the statement to be higher than the reliability of the appearance feature in which an ambiguous expression is used during the statement.

7. The processing apparatus according to claim 1, wherein
the witness information includes voice data indicating conversation content during the witness's statement, and
the at least one processor is further configured to execute the one or more instructions to determine the reliability of the appearance feature based on the voice data during the statement of the appearance feature.

8. The processing apparatus according to claim 7, wherein the at least one processor is further configured to execute the one or more instructions to determine the reliability of the appearance feature based on feature information of remarks including at least one of a feeling, a speaking tempo, and loudness of a voice of the witness during the statement of the appearance feature indicated by the voice data.

9. The processing apparatus according to claim 8, wherein the at least one processor is further configured to execute the one or more instructions to compare a plurality of the pieces of feature information of the remarks indicated by the voice data during the statement of each of a plurality of the appearance features stated by the witness with each other, and determine the reliability of the plurality of appearance features by relative evaluation.

10. The processing apparatus according to claim 8, wherein the at least one processor is further configured to execute the one or more instructions to determine the reliability of the appearance features further using the feature information of remarks indicated by voice data in a period of time in which the witness does not state about the appearance feature.

11. The processing apparatus according to claim 1, wherein the at least one processor is further configured to execute the one or more instructions to
acquire witness feature information indicating features of the witness, and
determine the reliability of the appearance features further using the witness feature information.

12. The processing apparatus according to claim 11, wherein the witness feature information includes at least one of a date and time of the witness, weather during the witness, an attribute of the witness, an elapsed time from a time of the witness to a time of the testimony, a temporal length in which the witness observes a witness target, and a distance between the witness and the witness target.

13. A processing method causing one or more computers to execute:
acquiring witness information indicating content of a witness's statement;
specifying appearance features of a plurality of items about a tracking target person based on the witness information; and
determining reliability of each of the specified appearance features based on the witness information; and
generating a search query used in a case of searching for the tracking target person in an image based on the specified appearance features and the reliability of each of the specified appearance features.

14. The processing method according to claim 13, wherein the one or more computers generate the search query including the appearance features of which reliability is equal to or more than a threshold and not including the appearance features of which reliability is below the threshold.

15. The processing method according to claim 13, wherein the one or more computers generate the search query including the appearance features that are specified based on the witness information and the appearance features that are not specified based on the witness information but have a similar relationship with the appearance features of which reliability is below the threshold.

16. The processing method according to claim 14, wherein the one or more computers generate the search query including the appearance feature that has a similar relationship with the appearance feature stated in a predetermined expression.

17. A non-transitory computer-readable medium storing a program that causes a computer to:
acquire witness information indicating content of a witness's statement;
specify appearance features of a plurality of items about a tracking target person based on the witness information;
determine reliability of each of the specified appearance features based on the witness information; and
generate a search query used in a case of searching for the tracking target person in an image based on the specified appearance features and the reliability of each of the specified appearance features.

18. The non-transitory computer-readable medium according to claim 17, wherein the program causes the computer to generate the search query including the appearance feature of which reliability is equal to or more than a threshold and not including the appearance feature of which reliability is below the threshold.

19. The non-transitory computer-readable medium according to claim 17, wherein the program causes the computer to generate the search query including the appearance features that are specified based on the witness information and the appearance features that are not specified based on the witness information but have a similar relationship with the appearance features of which reliability is below the threshold.

20. The non-transitory computer-readable medium according to claim 18, wherein the program causes the computer to generate the search query including the appearance feature that has a similar relationship with the appearance feature stated in a predetermined expression.
